(19) United States
(12) Patent Application Publication
(10) Pub. No.: US 2026/0063923 A1
(43) Pub. Date: Mar. 5, 2026

(54) Protective Cover

(71) Applicant: Mia Lizette Krayner, Beverly Hills, CA (US)

(72) Inventor: Mia Lizette Krayner, Beverly Hills, CA (US)

(21) Appl. No.: 18/824,820

(22) Filed: Sep. 4, 2024

(51) Int. Cl. G02C 5/22

(52) U.S. Cl. CPC G02C 5/22

(57) ABSTRACT

A protective cover is disclosed. The protective cover contains a main body, an extension, and an aperture configured to accommodate an earstem of an eyewear, wherein the extension is positioned to cover a gap formed between the earstem of the eyewear and the front portion of the eyewear when the main body is positioned away from the gap.

### FIELD

The present invention relates to a cover. More particularly, the present invention relates to a protective cover for eyewear.

### BACKGROUND

There are many different forms of eyewear, including eyeglasses, shields, goggles, etc. There are also many different forms of eyeglasses, including corrective or prescription eyeglasses, sunglasses, dual lens eyeglasses, glass-lens eyeglasses, polymer-lens eyeglasses, framed eyeglasses, etc. In some embodiments, eyewear includes a front portion with left and right orbitals which support optical lenses on opposing sides of a nose bridge. A pair of earstems that extend in a posterior (e.g., rearward) direction from the front portion. The earstems are pivotably connected with the front portion.

When a user wears the eyewear, the pivotable connection between the earstem and the front portion can become entangled with external objects, such as the wearer's hair, jewelry, etc.

Therefore, a need exists for a way to prevent the external objects from entangling with the pivotable connection between the earstem and the front portion of the eyeglasses.

### BRIEF DESCRIPTION OF THE FIGURES

FIG. 1 depicts a top view of a protective cover according to some embodiments presently disclosed.

FIG. 2 depicts a side view of the protective cover according to some embodiments presently disclosed.

FIG. 3 depicts another view of the protective cover according to some embodiments presently disclosed.

FIG. 4 depicts another view of the protective cover according to some embodiments presently disclosed.

FIG. 5 depicts another view of the protective cover according to some embodiments presently disclosed.

FIG. 6 depicts a perspective view of a protective cover according to some embodiments presently disclosed.

FIG. 7 depicts another perspective view of the protective cover according to some embodiments presently disclosed.

FIG. 8 depicts another perspective view of the protective cover according to some embodiments presently disclosed.

FIG. 9 depicts a side view of the protective cover according to some embodiments presently disclosed.

FIG. 10 depicts another view of the protective cover according to some embodiments presently disclosed.

FIG. 11 depicts another view of the protective cover according to some embodiments presently disclosed.

FIG. 12 depicts a top view of the protective cover according to some embodiments presently disclosed.

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

As described in subsequent paragraphs, the specific mechanical configurations illustrated in the drawings are intended to exemplify embodiments of the invention and that other alternative mechanical configurations are possible.

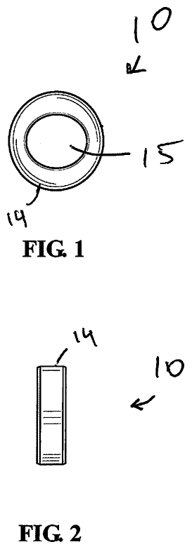

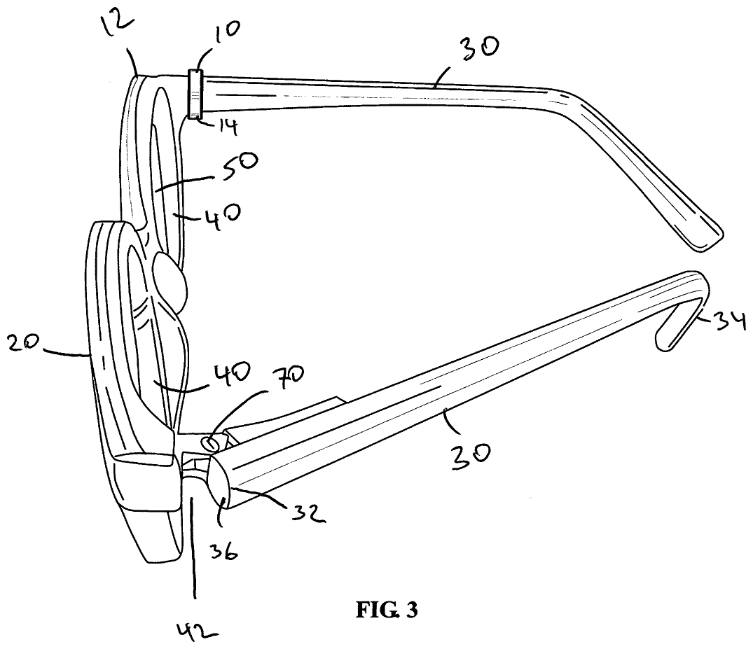

FIGS. 1-5 depict a protective cover 10 according to some embodiments presently disclosed. According to some embodiments presently disclosed, the protective cover 10 can be used or applied to any type of eyewear 12. The eyewear 12 can include a front portion 20 and a pair of earstem portions 30 for retaining the eyeglass on the head of a wearer (i.e. user). The front portion 20 can include a pair of lens supports, e.g. orbitals 40, which can be configured to support a pair of optical zones or lenses 50.

The earstems 30 can extend in a posterior direction from opposing lateral (e.g., outer) sides of the front portion 20. The earstems 30 comprise a front end 32 and a rear end 34.

According to some embodiments presently disclosed, the front end 32 comprises a front surface 36. According to some embodiments presently disclosed, the front end 32 of the earstem 30 is coupled to the front portion 20 by a hinge 70, to be movable between a folded position and an open position relative to the front portion 20. According to some embodiments presently disclosed, the front end 32 is positioned adjacent to the front portion 20 and the rear end 34 is positioned away from the front portion 20 when the earstem 30 is in the open position. According to some embodiments presently disclosed, the front end 32 is positioned away from to the front portion 20 and the rear end 34 is positioned adjacent to the front portion 20 when the earstem 30 is in the folded position.

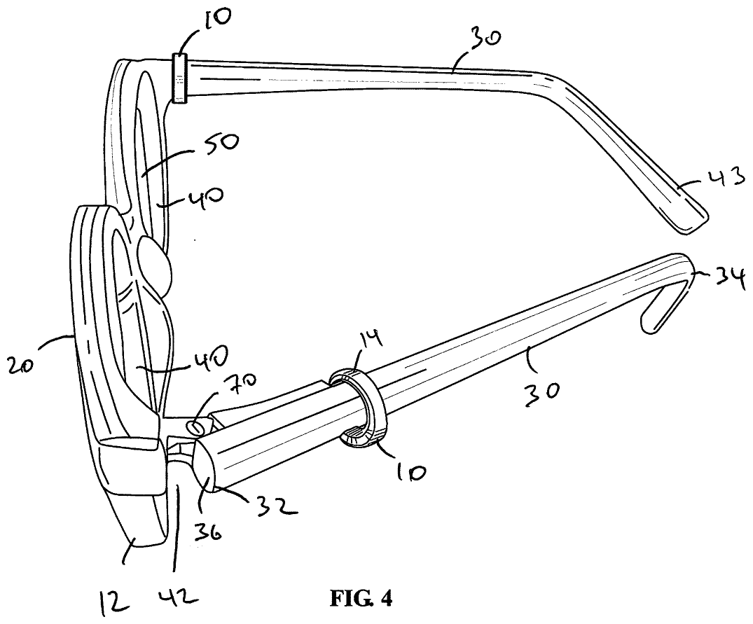

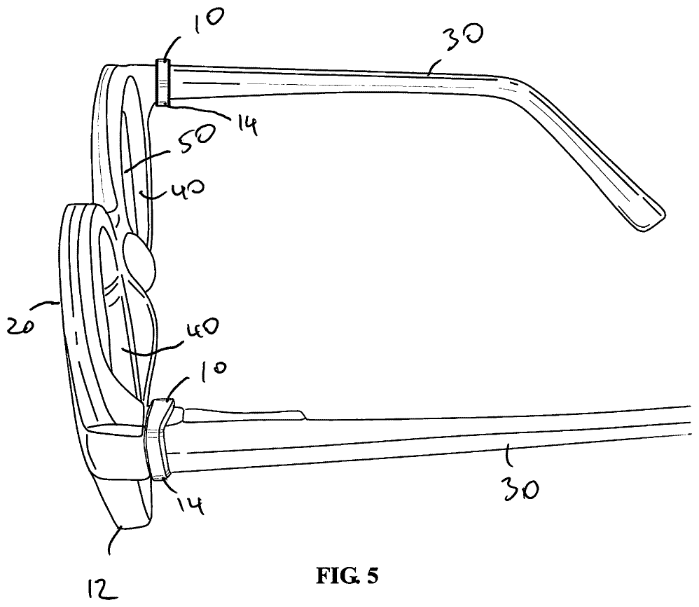

According to some embodiments presently disclosed, the protective cover 10 comprises a main body 14 and an aperture 15 (shown in FIG. 1) configured to accommodate the earstem 30 as shown in FIGS. 4-5.

According to some embodiments presently disclosed, the rear end 34 of the earstem 30 is inserted through the aperture 15 until the main body 14 is positioned at the front end 32. According to some embodiments presently disclosed, the rear end 34 of the earstem 30 is inserted through the aperture 15 until the main body 14 is positioned over the front end 32 and the hinge 70. According to some embodiments presently disclosed, the rear end 34 of the earstem 30 is inserted through the aperture 15 until the main body 14 is positioned over the front surface 36 and the hinge 70.

According to some embodiments presently disclosed, the rear end 34 of the earstem 30 is inserted through the aperture 15 until the main body 14 is positioned to cover a gap 42 formed between the front end 32 and the front portion 20. According to some embodiments presently disclosed, the rear end 34 of the earstem 30 is inserted through the aperture 15 until the main body 14 is positioned to cover a gap 42 formed between the front surface 36 and the front portion 20. According to some embodiments presently disclosed, the rear end 34 of the earstem 30 is inserted through the aperture 15 until the main body 14 is positioned to prevent the hinge 70 from entangling with external objects, such as the wearer's hair and/or jewelry. According to some embodiments presently disclosed, the main body 14 is positioned over the gap 42 formed between the front end 32 and the front portion 20. According to some embodiments presently disclosed, the main body 14 is positioned over the gap 42 formed between the front surface 36 and the front portion 20. According to some embodiments presently disclosed, the main body 14 is not positioned within the gap 42 formed between the front end 32 and the front portion 20. According to some embodiments presently disclosed, the main body 14 is not positioned within the gap 42 formed between the front surface 36 and the front portion 20. According to some embodiments presently disclosed, the main body 14 does not prevent the front end 32 from abutting the front portion 20. According to some embodiments presently disclosed, the main body 14 does not prevent the front surface 36 from abutting the front portion 20. According to some embodiments presently disclosed, the main body 14 does not prevent the front end 32 from physically touching the front portion 20. According to some embodiments presently disclosed, the main body 14 does not prevent the front surface 36 from physically touching the front portion 20.

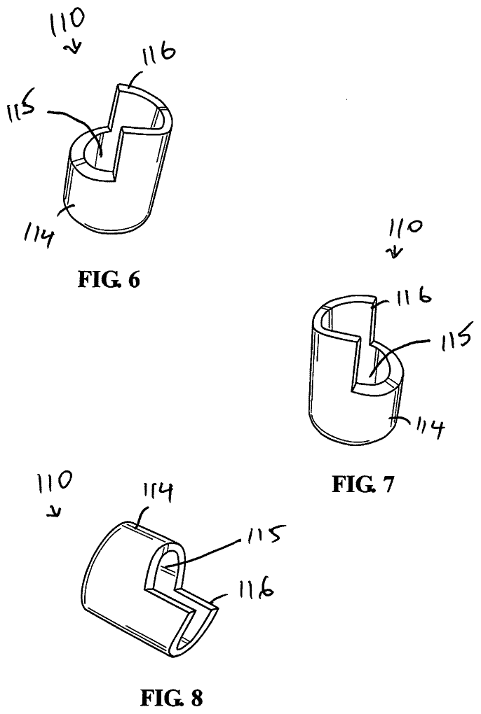

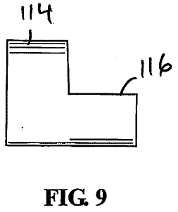

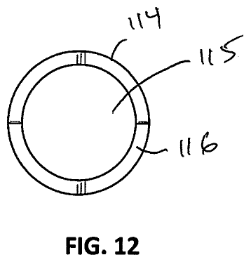

FIGS. 6-12 depict a protective cover 110 according to some embodiments presently disclosed. According to some embodiments presently disclosed, the protective cover 110 can be used or applied to any type of eyewear 12 as described above.

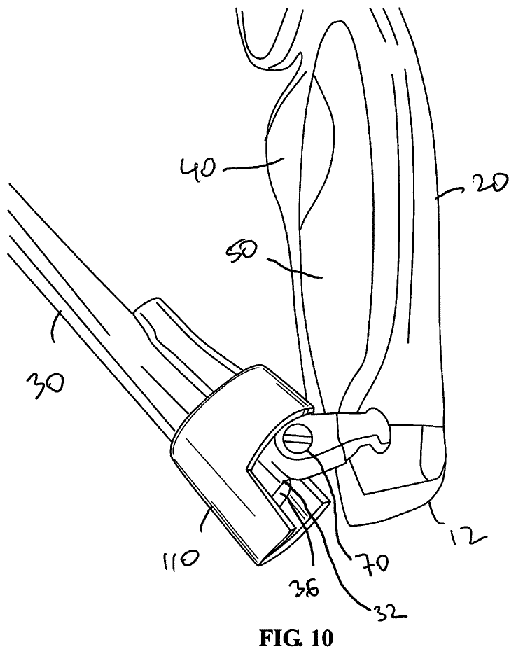

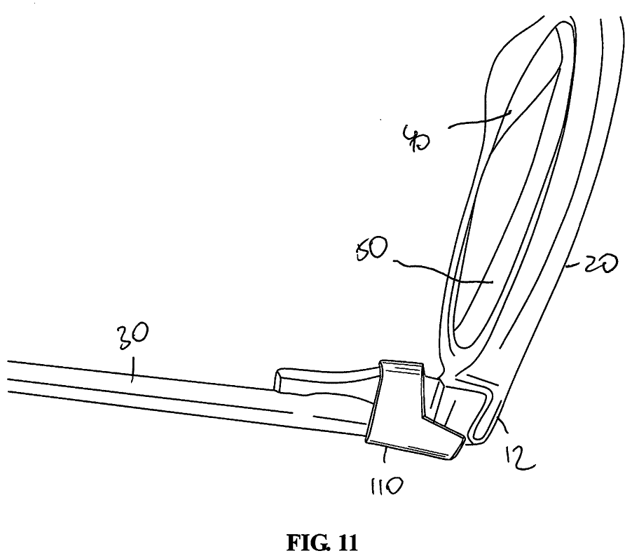

According to some embodiments presently disclosed, the protective cover 110 comprises a main body 114, an extension 116 extending from the main body 114, and an aperture 115 (shown in FIGS. 6-9) configured to accommodate the earstem 30 as shown in FIGS. 10-11.

According to some embodiments presently disclosed, the rear end 34 of the earstem 30 is inserted through the aperture 115 until the extension 116 is positioned at the front end 32. According to some embodiments presently disclosed, the rear end 34 of the earstem 30 is inserted through the aperture 115 until the extension 116 is positioned over the front end 32 and the hinge 70. According to some embodiments presently disclosed, the rear end 34 of the earstem 30 is inserted through the aperture 115 until the extension 116 is positioned over the front surface 36 and the hinge 70. According to some embodiments presently disclosed, the rear end 34 of the earstem 30 is inserted through the aperture 115 until the extension 116 is positioned over the front surface 36 and the front end 32.

According to some embodiments presently disclosed, the rear end 34 of the earstem 30 is inserted through the aperture 115 until the extension 116 is positioned to cover a gap 42 formed between the front end 32 and the front portion 20. According to some embodiments presently disclosed, the rear end 34 of the earstem 30 is inserted through the aperture 115 until the extension 116 is positioned to cover a gap 42 formed between the front surface 36 and the front portion 20. According to some embodiments presently disclosed, the rear end 34 of the earstem 30 is inserted through the aperture 115 until the extension 116 is positioned to prevent the hinge 70 from entangling with external objects, such as the wearer's hair and/or jewelry. According to some embodiments presently disclosed, only the extension 116 is positioned over the gap 42 formed between the front end 32 and the front portion 20. According to some embodiments presently disclosed, only the extension 116 is positioned over the gap 42 formed between the front surface 36 and the front portion 20. According to some embodiments presently disclosed, the extension 116 is not positioned within the gap 42 formed between the front end 32 and the front portion 20. According to some embodiments presently disclosed, the extension 116 is not positioned within the gap 42 formed between the front surface 36 and the front portion 20. According to some embodiments presently disclosed, the extension 116 does not prevent the front end 32 from abutting the front portion 20. According to some embodiments presently disclosed, the extension 116 does not prevent the front surface 36 from abutting the front portion 20. According to some embodiments presently disclosed, the extension 116 does not prevent the front end 32 from physically touching the front portion 20. According to some embodiments presently disclosed, the extension 116 does not prevent the front surface 36 from physically touching the front portion 20. According to some embodiments presently disclosed, the main body 114 is positioned away from the gap 42 formed between the front surface 36 and the front portion 20. According to some embodiments presently disclosed, the extension 116 extends beyond the front surface 36.

According to some embodiments presently disclosed, the extension 116 is C-shaped. According to some embodiments presently disclosed, the extension 116 is U-shaped.

According to some embodiments presently disclosed, the protective covers 10 and 110 comprise flexible material to allow the protective covers 10 and 110 to form around an outer surface of the earstem 30. According to some embodiments presently disclosed, the protective covers 10 and 110 comprise stretchy material to allow the protective covers 10 and 110 to slide over an outer surface of the earstem 30.

The front portion 20, earstems 30, orbitals 40 and lenses 50 can comprise any of many different shapes, sizes, materials and configurations. Injection molding, casting, machining, and other construction techniques for these components can be used.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S. C. Sec. 112, sixth paragraph, unless the element is expressly recited using the phrase “means for . . . ” and no method or process step herein is to be construed under those provisions unless the step, or steps, are expressly recited using the phrase “step(s) for. . . . ”

What is claimed is:

1. A protective cover comprising:
a main body;
an extension; and
an aperture configured to accommodate an earstem of an eyewear;
wherein the extension is positioned to cover a gap formed between the earstem of the eyewear and the front portion of the eyewear when the main body is positioned away from the gap.

2. The protective cover of claim 1, wherein the extension is C-shaped.

3. The protective cover of claim 1, wherein the extension is U-shaped.
